(19) United States
(12) Patent Application Publication
(10) Pub. No.: US 2004/0133854 A1
(43) Pub. Date: Jul. 8, 2004

(54) Persistent document object model

(76) Inventor: Karl S. Black, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/338,428

(22) Filed: Jan. 8, 2003

(51) Int. Cl. G06F 15/00

(52) U.S. Cl. 715/517; 715/530

(57) ABSTRACT

Various systems, methods, and programs embodied in a computer readable medium are provided for generating a document template repository. The document template repository includes various document object model elements that may be reused to create markup files or pages. In one embodiment, a method is provided that comprises the steps of isolating a number of document object model (DOM) elements in a DOM, generating and storing a template in a database, conditioning the DOM elements for storage in the database, associating the DOM elements with the template, and, storing the DOM elements in the database.

### CROSS REFERENCE TO RELATED APPLICATIONS

This application is related to U.S. patent application entitled “GENERATION OF PERSISTENT DOCUMENT OBJECT MODELS” filed on even date herewith and afforded Ser. No. ______ (Attorney Docket Number 100202847-1).

### BACKGROUND OF THE INVENTION

The creation of markup files that are employed, for example, as pages available on the Internet using the World Wide Web can be time consuming. Also, a relatively high degree of technical competency is required to create markup files, etc. Due to the time involved and the required technical skill, the cost to create markup files or pages can be significant. For example, a web site created using an appropriate markup language such as Hypertext Markup Language (HTML) or Extensible Markup Language (XML) can be significant to the average businesses that need a presence on the World Wide Web.

Sometimes in creating a web site or other markup page/file, a programmer might copy code from an existing markup file into a new markup file to copy a feature of a markup page, etc. This speeds up the process of generating a new markup page or file by reducing the amount of original programming that has to be performed. Unfortunately, copying portions of existing markup files or pages can also be time consuming and requires the technical skill to recognize the portions of code in such existing markup files or pages that is to be copied.

### SUMMARY OF THE INVENTION

In view of the foregoing, the present invention provides for various systems, methods, and programs embodied in a computer readable medium that generate a document template repository. The document template repository includes various document object model elements that may be reused to create markup files or pages. In one embodiment, a method is provided that comprises the steps of isolating a number of document object model (DOM) elements in a DOM, generating and storing a template in a database, conditioning the DOM elements for storage in the database, associating the DOM elements with the template, and, storing the DOM elements in the database.

In another embodiment, a program embodied in a computer readable medium is provided for generating a document template repository. In this regard, the computer program comprises code that isolates a number of document object model (DOM) elements in a DOM and code that generates and stores a template in a database. The program also comprises code that conditions the DOM elements for storage in the database, code that associates the DOM elements with the template, and code that stores the DOM elements in the database.

In still another embodiment, a system for generating a document template repository is provided. In this respect, the system comprises a processor circuit having a processor and a memory. Template generation logic is stored in the memory and is executable by the processor. The template generation logic comprises logic that isolates a number of document object model (DOM) elements in a DOM, logic that generates and stores a template in a database, logic that conditions the DOM elements for storage in the database, logic that associates the DOM elements with the template, and logic that stores the DOM elements in the database.

In another embodiment, a system for generating a document template repository is provided that comprises means for isolating a number of document object model (DOM) elements in a DOM, means for generating and storing a template in a database, means for conditioning the DOM elements for storage in the database, means for associating the DOM elements with the template, and means for storing the DOM elements in the database.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a schematic of an example of a template repository system that includes a processor circuit according to an embodiment of the present invention;

FIG. 2A is a drawings of an exemplary markup file from which a Document Object Model (DOM) can be generated that is stored in the template repository system of FIG. 1;

FIG. 2B is a drawing of a DOM created from the markup file of FIG. 2A;

FIG. 3 is a block diagram of a template database stored in a memory of the template repository system of FIG. 1 according to an embodiment of the present invention; and

FIGS. 4A-4C are flow charts that provide an example of the operation of a template generator executed in the template repository system of FIG. 1 according to an embodiment of the present invention.

### DETAILED DESCRIPTION OF THE INVENTION

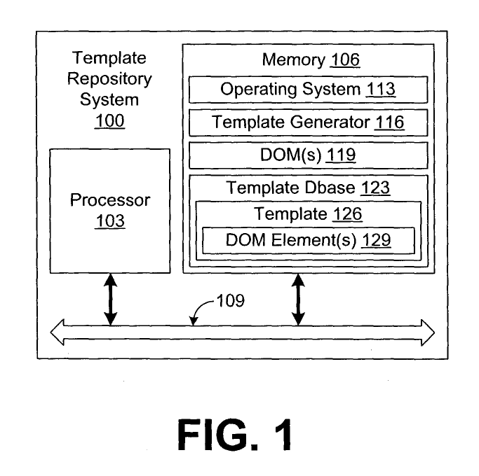

With reference to FIG. 1, shown is a block diagram of a template repository system 100 according to an embodiment of present invention. The template repository system 100 includes a processor circuit having a processor 103 and the memory 106, both of which are coupled to a local interface 109. Local interface 109 may be, for example, a data bus with an accompanying control/address bus as can be appreciated by those with ordinary skill in the art. In this respect, the template repository system 100 may be, for example, the computer system or other device with like capability.

A number of software components are stored in memory 106 and are executable by the processor 103 according to an aspect of present invention. These software components include, for example, an operating system 113, a template generator 116, one or more document object models (DOMs) 119, and a template database 123. Stored within the template database 123 are a number of templates 126. Each of the templates 126 embodies a particular DOM 119 and includes one or more DOM elements 129 as will be discussed. The DOM elements 129 comprise portions or nodes of the DOM 119. The templates 126 are “forms” of documents that can ultimately be translated into an appropriate markup language. In this regard, the templates 126 store all of the DOM elements 129 of a particular a DOM 119 using the language of the DOM 119 itself.

The templates 126 may thus be used to create new documents such as web sites, for example, or other documents that are expressed in an appropriate markup language. Specifically, rather than creating a web site or other document in a markup language such as HTML or XML, a user may access templates 126 stored in a nonvolatile portion of the memory 106. As will be discussed, the DOM elements 129 are stored within each of the templates 126 in a manner that allows a user to access either the entire template 126 or individual DOM elements 129 to be used to create a new document as is desired.

The memory 106 is defined herein as both volatile and nonvolatile memory and data storage components. Volatile components are those that do not retain data values upon loss of power. Nonvolatile components are those that retain data upon a loss of power. Thus, the memory 106 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 103 may represent multiple processors and the memory 106 may represent multiple memories that operate in parallel. In such a case, the local interface 109 may be an appropriate network that facilitates communication between any two of the multiple processors, between any processor and any one of the memories, or between any two of the memories etc.

The operating system 113 is executed to control the allocation and usage of hardware resources in the template repository system 100 such as the memory, processing time and peripheral devices. In this manner, the operating system 113 serves as the foundation on which applications depend as is generally known by those with ordinary skill in the art.

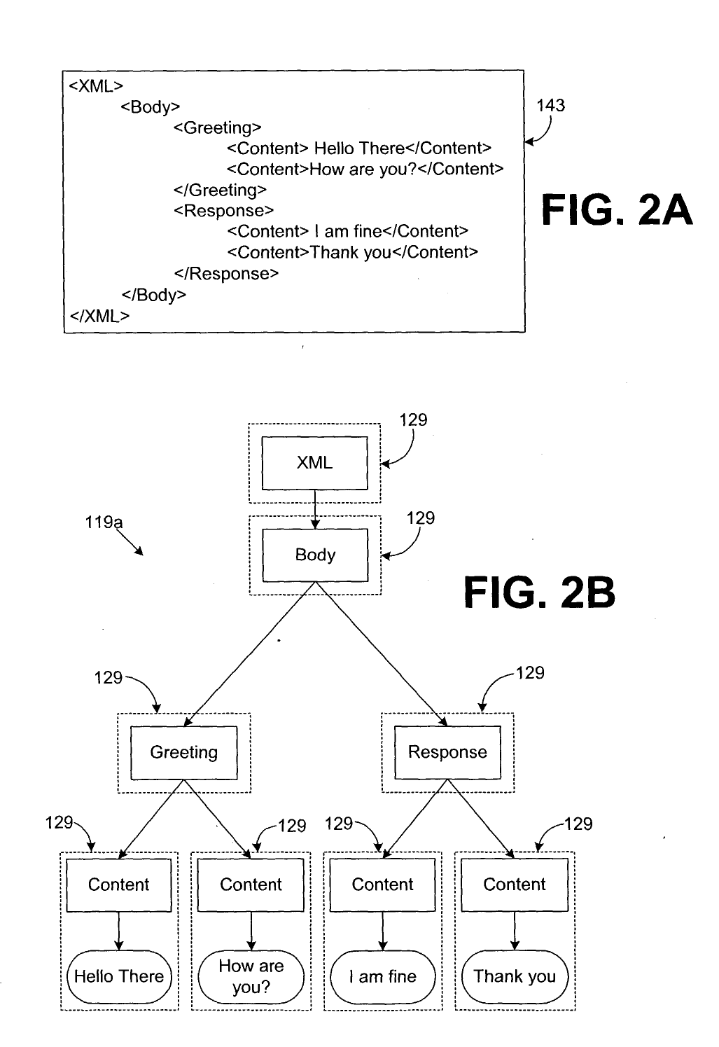

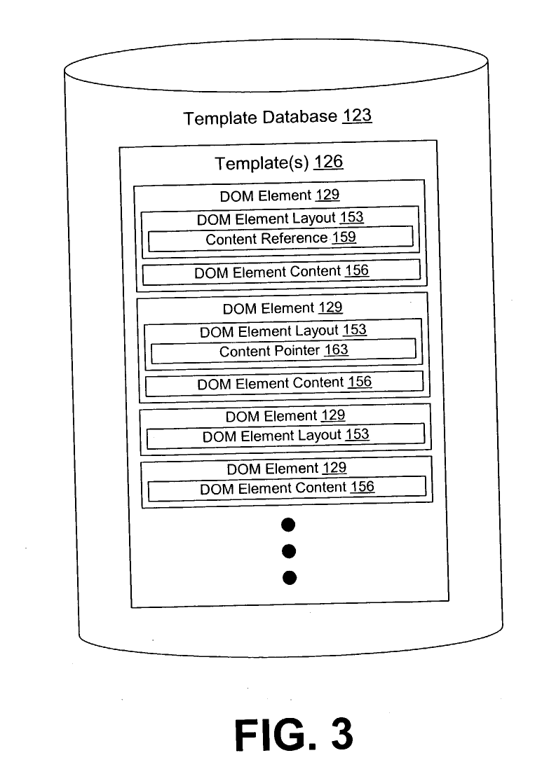

With reference to FIG. 2A, shown is an example of an XML document 143 to provide an illustration of an original document that may be represented by a DOM. As shown, the XML document 143 includes a number of tags or nodes and content items that are nested in accordance with the organization of the document.

Referring then, to FIG. 2B, shown is a representation of the above XML document 143 in the form of a DOM 119 that is denoted herein as DOM 119a. As shown in the DOM 119a, documents have a logical structure that is much like a tree. In this sense, the DOM 119a includes a number of DOM elements 129 that can also be described as “nodes”. The DOM elements 153 are depicted in FIG. 2B without regard to their nature or type. That is to say, each of the DOM elements 153 may include characteristics that differ from the characteristics of the remaining ones of the DOM elements 153. A DOM 119a is an “object model” in the traditional object oriented design sense. That is to say, documents are modeled using objects, and the model encompasses not only the structure of the document, but also the behavior of a document and the objects of which it is composed. In other words, the nodes or DOM elements 129 shown in FIG. 2 do not represent a data structure, they represent objects that have functions and identity.

In this sense, a DOM is defined as an application programming interface (API) for markup files such as HTML documents, XML documents, or other markup documents. As contemplated herein, the term “document” refers to a document that is rendered and viewed by an individual using, for example, a display device, printer, or other device.

The Document Object Model allows programmers to build documents, navigate their structure, and add, modify, or delete elements or content. Although there are some exceptions, generally any layout or content information found in an HTML or XML document or other type of Markup file can be accessed, changed, deleted, or added using a DOM.

As an object model, a DOM 119 identifies the interfaces and objects used to represent and manipulate a document, the semantics of these interfaces and objects including both behavior and attributes, and the relationships and collaborations among these interfaces and objects. In this sense, a DOM 119 specifies how XML, HTML, or other markup files may be represented as objects so that they may be used in object oriented programs and the like. Thus, a DOM 119 provides an object model that specifies interfaces in the sense that, although a document contains diagrams showing parent/child relationships, these are logical relationships defined by the programming interfaces, not representations of any particular internal data structures. To obtain greater detail about DOMs 119, reference is made to Wood et al., Document Object Model (DOM) Level 1 Specification, Version 1.0, W3C Recommendation, 1 Oct. 1998, which is incorporated herein in its entirety.

While a DOM 119 allows programmers to build documents, navigate their structure, and add, modify, or delete elements or content, the ultimate expression of the layout and content expressed therein is stored in non-volatile memory as a markup file such as, for example, an HTML or XML document. In other words, a DOM 119 is expressed in a format that allows for storage and manipulation in random access memory (RAM). When a document expressed as a DOM 119 is stored in non-volatile memory such as, for example, a hard drive, disk drive, etc., the document is translated back into the markup language from which it came such as HTML, XML, or other markup language as is conventional.

The template repository system 100 provides for convenient storage of various elements of a DOM 119 in nonvolatile memory. In this sense, the DOM 119 becomes a persistent DOM 119 as it “persists” beyond the actual run time when it is stored and accessed in RAM by a given application. In order to store a DOM 119 in non-volatile memory for future access, the DOM 119 is packaged in a manner that the various relationships between nodes are maintained. Specifically, templates 126 include the DOM elements 129 in a form that maintains the interfaces and objects used to represent and manipulate a document, the semantics of these interfaces and objects including both behavior and attributes, and the relationships and collaborations among these interfaces and objects. Also, the layout data contained in the DOM 119 is separated from the content data so that the layout inherent in the DOM 119 may be accessed for future use with different content as will be discussed.

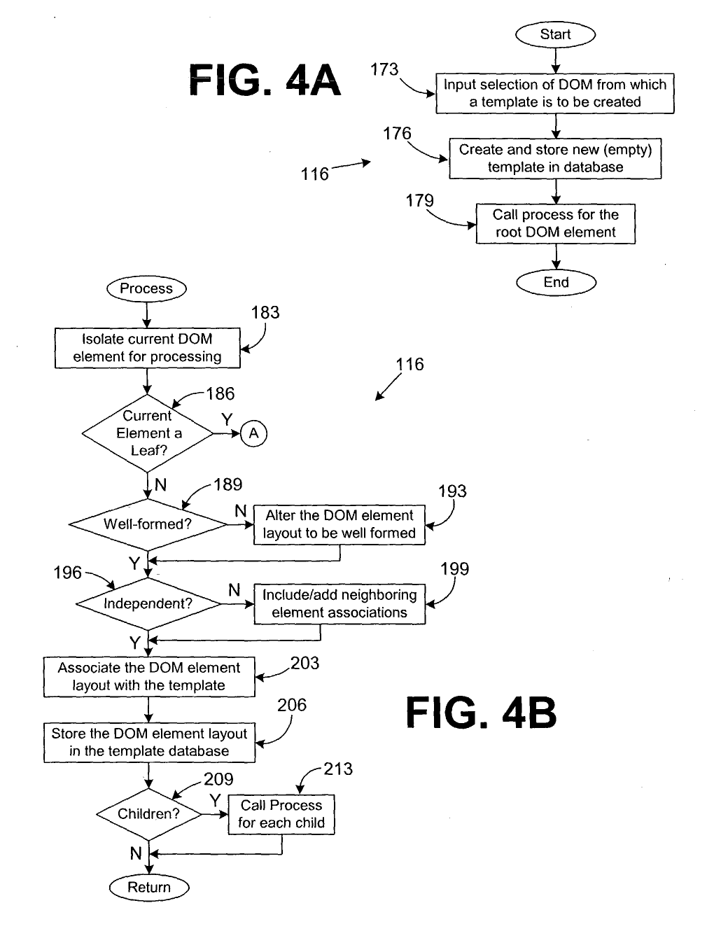

Referring next to FIG. 3, shown is a block diagram of the template database 123 according to an embodiment of the present invention. The template database 123 includes one or more templates 126. Each template includes one or more DOM elements 129. Each of the DOM elements 129 comprises a portion of the DOM 119 (FIG. 2B) that is extrapolated from a respective node in the DOM 119. In this respect, each of the DOM elements 129 may comprise layout data, content data, or both layout data and associated content. Accordingly, each of the DOM elements 129 may be expressed as a combination of a DOM element layout 153 and a DOM element content 156. Alternatively, the DOM element 129 may also comprise either the DOM element layout 153 or the DOM element content 156, depending upon the nature of the DOM element 129 itself.

The DOM element layout 153 includes the layout data which describes the structural nature of a DOM element 129. For example, the DOM element layout 153 may include, for example, content type designations, region size, region shape, region location, nested template references, sub-regions included within a region, as well as other attributes, etc. The DOM element content 156 is an item of content that is displayed or otherwise rendered within the region defined by the DOM element layout 153. In this respect, the DOM element content 156 may be, for example, text, images, or other content.

In creating templates 126 from an existing markup file, the DOM element layout 153 is separated from the DOM element content 156. This is done so that the layout of a DOM 119 or a specific DOM element 129 that is expressed in a template 126 may be employed with or without the content to generate new documents therefrom. Thus, a user may access any one of the templates 126 without the DOM element content 156 associated therewith. Thus, the templates 126 are reusable such that a user may access the templates 126 and generate new documents. When accessed, the templates 126 may be stored in memory as a DOM 141 that may be further manipulated based upon the desires of a user. Specifically, a user may access the DOM element layouts 153 associated with a particular template 126 so that the layout of a new document can be instantly created therefrom. Thereafter, a user can associate any content they wish with the DOM element layouts 153 included therein. Similarly, it may be the case that one may wish to access the content contained within various DOM element content 156.

The DOM element layout 153 and the DOM element content 156 that make up a particular DOM element 129 may be associated with each other using, for example, a content reference. Specifically, when placing a particular DOM element 129 into the template database 123 in association with a respective template 126, the content contained therein may be removed and stored as a separate DOM content element 156. The corresponding DOM layout element 153 thus remains with the content removed. A content reference 159 is inserted into the DOM layout element 153 in place of the removed content to associate the corresponding DOM element content 156 therewith. Alternatively, a content pointer 163 may be inserted into the DOM element layout 153 that indicates a location in the template database 123 or other location where content may be found that is to be included as the content of the corresponding DOM element 129.

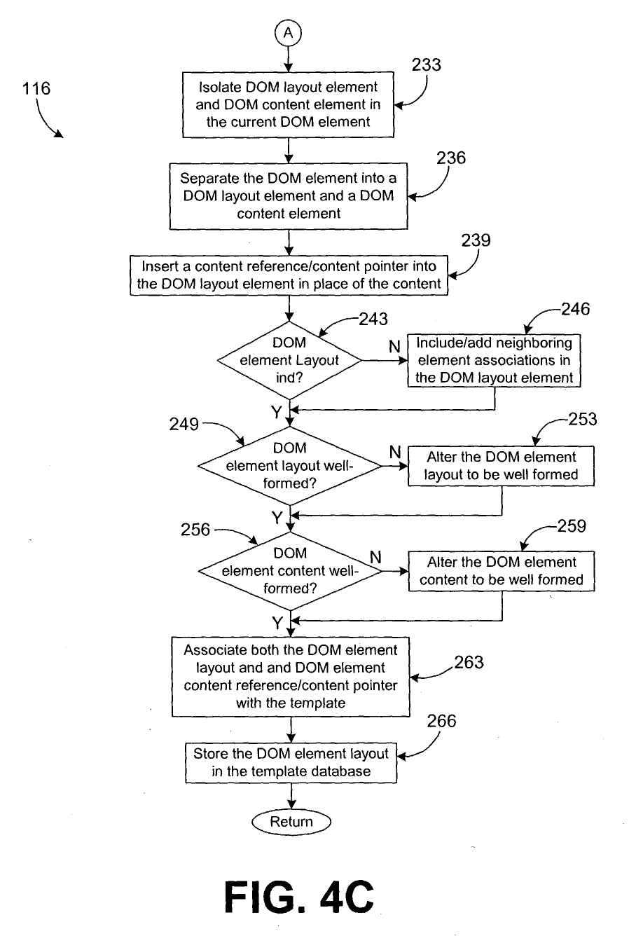

Turning then, to FIGS. 4A-4C, shown is a series of flow charts that illustrate one example of the operation of the template generator 116 in creating templates 126 from DOMs 119 as described above according to an embodiment of the present invention. Alternatively, the flow chart of FIGS. 4A-4C may be viewed as depicting steps of an exemplary method implemented in the template repository system 100 to create the templates 126 in the template database 123.

Beginning with box 173, a DOM 119 (FIG. 2B) is input from which a particular template is to be created. If not already included in the random access memory, an appropriate DOM may be generated by parsing a corresponding markup file using a parser. Once the DOM 119 is input in box 173, the template generator 116 proceeds to box 176 to create and store a new template 126 in the template database 123. At this point, the template is empty as no DOM elements 129 have been included. Thereafter, in box 179 a recursive process is called for the root DOM element 129 in the respective DOM 119. Thereafter, the template generator 116 ends as shown.

With specific reference to FIG. 4B, shown is a first portion of the recursive process called in box 179 (FIG. 4A). The recursive process begins at box 183 in which a current DOM element 183 for which the recursive process was called is isolated. To isolate the DOM element 183, a starting point and an ending point of the respective DOM element 129 is identified. In this regard, the template generator 116 looks for specific syntax within of the DOM 119 from which the starting point and the ending point can be ascertained. Thereafter, in box 186, the template generator 116 determines whether the current DOM element is a leaf such that it does not include any further nested or children elements/nodes. If so, then the template generator 116 proceeds to connector A as shown. Otherwise, it is assumed that there is no content involved in the current DOM element 129 (i.e. there is no DOM element content 156) and the template generator 116 moves to box 189. In box 189 the template generator 116 determines whether the DOM element layout 153 is well-formed based upon a set of rules that define whether a DOM element layout 153 is well-formed.

If not, then the template generator 116 proceeds to box 193. Otherwise, the template generator 116 moves to box 196. In box 193 the DOM element layout 153 is altered so as to be well-formed. The precise alterations may entail, for example, the inclusion of closing tags where they are not present or the inclusion of information relating to neighboring relationships with other DOM elements 153 such as the case where a particular DOM element 153 is a cell within a table or other structure, etc. Thereafter, the template generator 116 moves on to box 196. In box 196 the template generator 116 determines whether the current DOM element layout 153 is independent of neighboring DOM elements 129. A DOM element layout 153 that is not independent might include a DOM element layout 153 that is includes a relationship with neighboring DOM elements 129. Thus, a DOM element layout 153 that lacks independence may be; for example, a DOM element layout 153 of a cell in a table, where the layout of the individual cell depends upon its location within the table such as the row and column, etc.

If the DOM element layout 153 is not independent of other DOM elements 129, then the template generator 116 proceeds to box 199. Otherwise, the template generator 116 proceeds to box 203. In box 199, all existing neighboring element associations are included in the DOM element layout 153. Also, any neighboring element associations that need to be created are added to the DOM element layout 153. Thereafter, the template generator 116 moves to box 203 in which the DOM element layout 153 is associated with the template 126 created in box 176. This may be done, for example, by including a template identifier in the DOM element layout 153 that is associated with the template 126 or by using some other approach.

Next, in box 206 the DOM layout element 153 is stored in the template database 123 as a part of the template 126 due to the association created in box 203. Then, in box 209 it is determined whether the current DOM element 129 or node has any children nodes. If so, then the template generator 116 proceeds to box 213. Otherwise, the operation of the template generator 116 ends accordingly. In box 213, the recursive process is called for each of the children nodes of the current node/DOM element 129. Thereafter, the template generator 116 ends.

With reference to FIG. 4C, assuming that it was determined that the current DOM element 129 under consideration is a leaf node in box 186, then in box 233 the template generator 116 isolates the DOM element layout 153 and the DOM element content 156 of the current DOM element 129. This may be done, for example, by determining a starting point and an ending point of the DOM element layout 153 and the DOM element content 156, respectively. In this regard, the template generator 116 looks for specific syntax within of the DOM 119 from which the starting points and the ending points can be ascertained. Then, in box 236 the current DOM element 129 is separated into a DOM element layout 153 and a DOM element content 156. This may be done, for example, by removing the DOM element content 156 from the DOM element 129 itself, where the DOM layout element 153 remains.

Thereafter, in box 239 a content reference 159 (FIG. 3) or content pointer 163 (FIG. 3) is inserted into the DOM element layout 153. The content reference 159 is associated directly with the DOM element content 156 and thereby associates the DOM element content 153 with the DOM element layout 153. Alternatively, the content pointer 163 is associated with a specific location in the memory 106 (FIG. 1). In this respect, the content that is stored in the location associated with the content pointer 163 is correspondingly associated with the DOM layout element 153.

Next, in box 243 it is determined whether the DOM element layout 153 is independent of other neighboring DOM elements 129. If not, then the template generator 116 proceeds to box 246. Otherwise, the template generator 116 progresses to box 249. In box 246 all associations with neighboring elements are included and/or added in the DOM element layout 153. Thereafter, the template generator 116 proceeds to box 249.

In box 249 it is determined whether the DOM element layout 153 is well-formed according to the rules that define whether an element is well-formed in a DOM. If not, then the template generator 116 proceeds to box 253. Otherwise, the template generator 116 progresses to box 256. In box 253 the DOM element layout 153 is altered so as to be well-formed. The alteration may comprise, for example, including needed tags or other elements of syntax that are needed. Thereafter, the template generator 116 proceeds to box 256.

In box 256 it is determined whether the DOM element content 156 is well-formed according to the rules that define whether an element is well-formed in a DOM. If not, then the template generator 116 proceeds to box 259. Otherwise, the template generator 116 progresses to box 263. In box 259 the DOM element content 156 is altered so as to be well-formed. The alteration may comprise, for example, including needed tags or other elements of syntax that are needed. Thereafter, the template generator 116 proceeds to box 263.

In box 263 both the DOM element layout 153 and the associated content reference/content pointer are associated with the current template 123 created in box 176 (FIG. 4A). This association may be accomplished, for example, by including a template identifier in the DOM element layout 153 using some other approach. Thereafter, in box 266 the DOM element layout 153 with the content reference/content pointer are stored in the template database 123 as part of the template 126. In addition, the DOM element content 156 may be stored in the template database 123 or some other location in memory as identified by an appropriate content pointer, etc. Thereafter, the template generator 126 ends.

Although the example of the template generator 116 illustrated in FIGS. 4A-4C is depicted as being embodied in software or code executed by general purpose hardware as discussed above, as an alternative the same may also be embodied in dedicated hardware or a combination of software/general purpose hardware and dedicated hardware. If embodied in dedicated hardware, the template generator 116 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 4A-4C show an example of the architecture, functionality, and operation of an implementation of the template generator 116. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the exemplary flow charts of FIGS. 4A-4C show a specific order of execution, it is understood that the order of execution may differ from that which is depicted. For example, the order of execution of two or more blocks may be scrambled relative to the order shown. Also, two or more blocks shown in succession in FIGS. 4A-4C may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the template generator 116 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the template generator 116 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A method for generating a document template repository, comprising:
isolating a number of document object model (DOM) elements in a DOM;
generating and storing a template in a database;
conditioning the DOM elements for storage in the database;
associating the DOM elements with the template; and
storing the DOM elements in the database.

2. The method of claim 1, wherein the step of isolating document object model (DOM) elements in a DOM further comprises the steps of:
identifying a starting point of each of the DOM elements; and
identifying an ending point of each of the DOM elements.

3. The method of claim 1, wherein the step of conditioning the DOM elements for storage in the database further comprises the step of separating at least one of the DOM elements into a DOM layout element and a DOM content element, wherein the template may be accessed without the DOM content element.

4. The method of claim 3, wherein the step of associating the DOM elements with the template further comprises the step of associating both the DOM layout element and the DOM content element with the template.

5. The method of claim 3, wherein the step of separating at least one of the DOM elements into the DOM layout element and the DOM content element further comprises the steps of:
isolating the DOM content element within the DOM element;
removing the DOM content element from the DOM element, wherein the DOM layout element remains.

6. The method of claim 5, further comprising the step of altering the DOM content element into a well-formed state according to a set of predefined rules.

7. The method of claim 3, wherein the step of conditioning the DOM elements for storage in the database further comprises the steps of:
determining whether the DOM layout element is independent of other ones of the DOM elements; and
writing at least one neighboring association with the other ones of the DOM elements into the DOM layout element when the DOM layout element is not independent of the other ones of the DOM elements.

8. The method of claim 3, wherein the step of conditioning the DOM elements for storage in the database further comprises the steps of:
determining whether the DOM layout element is well-formed according to a set of predefined rules; and
altering the DOM layout element into a well-formed state if the DOM layout element is not well-formed.

9. The method of claim 5, further comprising the step of writing a content reference into the DOM layout element that associates the DOM content element with the DOM layout element.

10. The method of claim 5, further comprising the step of writing a content pointer into the DOM layout element that associates a memory location at which a predefined DOM content element may be stored.

11. The method of claim 10, further comprising the step of associating the predefined DOM content element with the DOM layout element by storing the predefined DOM content element at the memory location.

12. A program embodied in a computer readable medium for generating a document template repository, comprising:
code that isolates a number of document object model (DOM) elements in a DOM;
code that generates and stores a template in a database;
code that conditions the DOM elements for storage in the database;
code that associates the DOM elements with the template; and
code that stores the DOM elements in the database.

13. The program embodied in the computer readable medium of claim 12, wherein the code that isolates document object model elements in a DOM further comprises:
code that identifies a starting point of each of the DOM elements; and
code that identifies an ending point of each of the DOM elements.

14. The program embodied in the computer readable medium of claim 12, wherein the code that conditions the DOM elements for storage in the database further comprises the code that separates at least one of the DOM elements into a DOM layout element and a DOM content element, wherein the template may be accessed without the DOM content element.

15. The program embodied in the computer readable medium of claim 14, wherein the code that associates the DOM elements with the template further comprises code that associates the DOM layout element with the template.

16. The program embodied in the computer readable medium of claim 14, wherein the code that separates at least one of the DOM elements into the DOM layout element and the DOM content element further comprises:
code that isolates the DOM content element within the DOM element;
code that removes the DOM content element from the DOM element, wherein the DOM layout element remains.

17. The program embodied in the computer readable medium of claim 16, further comprising code that alters the DOM content element into a well-formed state according to a set of predefined rules.

18. The program embodied in the computer readable medium of claim 14, wherein the code that conditions the DOM elements for storage in the database further comprises:
code that determines whether the DOM layout element is independent of other ones of the DOM elements; and
code that writes at least one neighboring association with the other ones of the DOM elements into the DOM layout element when the DOM layout element is not independent of the other ones of the DOM elements.

19. The program embodied in the computer readable medium of claim 14, wherein the code that conditions the DOM elements for storage in the database further comprises:
code that determines whether the DOM layout element is well-formed according to a set of predefined rules; and
code that alters the DOM layout element into a well-formed state if the DOM layout element is not well-formed.

20. The program embodied in the computer readable medium of claim 16, further comprising code that writes a content reference into the DOM layout element that associates the DOM content element with the DOM layout element.

21. The program embodied in the computer readable medium of claim 16, further comprising code that writes a content pointer into the DOM layout element that associates a memory location at which a predefined DOM content element may be stored.

22. The program embodied in the computer readable medium of claim 21, further comprising code that associates the predefined DOM content element with the DOM layout element by storing the predefined DOM content element at the memory location.

23. A system for generating a document template repository, comprising:
a processor circuit having a processor and a memory;
template generation logic stored in the memory and executable by the processor, the template generation logic comprising:
logic that isolates a number of document object model (DOM) elements in a DOM;
logic that generates and stores a template in a database;
logic that conditions the DOM elements for storage in the database;
logic that associates the DOM elements with the template; and
logic that stores the DOM elements in the database.

24. The system of claim 23, wherein the logic that conditions the DOM elements for storage in the database further comprises the logic that separates at least one of the DOM elements into a DOM layout element and a DOM content element, wherein the template may be accessed without the DOM content element.

25. The system of claim 24, wherein the logic that associates the DOM elements with the template further comprises logic that associates the DOM layout element with the template.

26. The system of claim 24, wherein the logic that separates at least one of the DOM elements into the DOM layout element and the DOM content element further comprises:
logic that isolates the DOM content element within the DOM element;
logic that removes the DOM content element from the DOM element, wherein the DOM layout element remains.

27. The system of claim 26, further comprising logic that alters the DOM content element into a well-formed state according to a set of predefined rules.

28. The system of claim 24, wherein the logic that conditions the DOM elements for storage in the database further comprises:
logic that determines whether the DOM layout element is independent of other ones of the DOM elements; and
logic that writes at least one neighboring association with the other ones of the DOM elements into the DOM layout element when the DOM layout element is not independent of the other ones of the DOM elements.

29. The system of claim 24, wherein the logic that conditions the DOM elements for storage in the database further comprises:
logic that determines whether the DOM layout element is well-formed according to a set of predefined rules; and
logic that alters the DOM layout element into a well-formed state if the DOM layout element is not well-formed.

30. The system of claim 26, further comprising logic that writes a content reference into the DOM layout element that associates the DOM content element with the DOM layout element.

31. The system of claim 26, further comprising logic that writes a content pointer into the DOM layout element that associates a memory location at which a predefined DOM content element may be stored.

32. The system of claim 31, further comprising logic that associates the predefined DOM content element with the DOM layout element by storing the predefined DOM content element at the memory location.

33. A system for generating a document template repository, comprising:
means for isolating a number of document object model (DOM) elements in a DOM;
means for generating and storing a template in a database;
means for conditioning the DOM elements for storage in the database;
means for associating the DOM elements with the template; and
means for storing the DOM elements in the database.

34. The system of claim 33, wherein the means for conditioning the DOM elements for storage in the database further comprises the means for separating at least one of the DOM elements into a DOM layout element and a DOM content element, wherein the template may be accessed without the DOM content element.

35. The system of claim 34, wherein the means for associating the DOM elements with the template further comprises means for associating the DOM layout element with the template.

36. The system of claim 34, wherein the means for separating at least one of the DOM elements into the DOM layout element and the DOM content element further comprises:
means for isolating the DOM content element within the DOM element;
means for removing the DOM content element from the DOM element, wherein the DOM layout element remains.
